(19) United States
(12) Patent Application Publication
(10) Pub. No.: US 2005/0255344 A1
(43) Pub. Date: Nov. 17, 2005

(54) Fuel cell-use liquid fuel and fuel cell using this, and application method for fuel cell using this

(75) Inventors: Hideto Imai, Tokyo (JP); Tsutomu Yoshitake, Tokyo (JP); Yuichi Shimakawa, Tokyo (JP); Takashi Manako, Tokyo (JP); Shin Nakamura, Tokyo (JP); Hidekazu Kimura, Tokyo (JP); Sadanori Kuroshima, Tokyo (JP); Yoshimi Kubo, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 10/515,769

(22) PCT Filed: May 28, 2003
(86) PCT No.: PCT/JP03/06705

§ 371 Date: Apr. 4, 2005

(30) Foreign Application Priority Data
May 28, 2002 (JP) 2002-154491

(51) Int. Cl. H01M 8/00; C10L 1/10; C10L 1/22; C10L 1/18; H01M 8/10; C10L 1/26; C10L 1/24

(52) U.S. Cl. 429/13; 429/30; 44/375; 44/385; 44/387; 44/418; 44/451; 44/300

(57) ABSTRACT

A liquid fuel for a fuel cell comprises an organic compound and at least one kind of anti foaming agent. A catalyst electrode is capable of, when used for a fuel cell, increasing in an effective surface area of a fuel electrode and increasing in an output power of the fuel cell, by suppressing adsorption onto the surface of the electrode of an air which is a by-product produced at the fuel electrode as well as by quickly removing the foamed air which is once adsorbed thereto.

### TECHNICAL FIELD

The present invention relates to a liquid fuel for a fuel cell, a fuel cell using the liquid fuel, and a method for using the fuel cell using the liquid fuel. For explaining sufficiently on the current technology status of the related arts, all descriptions such as patents, patent applications, patent gazettes, and scientific literatures, which are cited or specified in the instant application, are incorporated herein by reference for explaining each technology.

### BACKGROUND OF THE ART

A solid electrolyte fuel cell is an apparatus for generating an electric power through an electrochemical reaction by supplying hydrogen or methanol to a fuel electrode and oxygen to an oxidation electrode. The fuel cell has a solid electrolyte membrane such as a perfluorosulfonic acid membrane as an electrolyte. The fuel electrode and the oxidation electrode are bonded to both sides of the solid electrolyte membrane.

When methanol is used as the fuel, the electrochemical reaction on the fuel electrode is shown in formula (1).
CH₃OH+H₂O→6H++CO₂+6e− (1),
A reaction on the oxidation electrode is shown in formula (2).
3/2O₂+6H++6e−→3H₂O (2).

The fuel electrode and the oxidation electrode are composed of a mixture of fine carbon particles supporting a catalyst and a solid polymer electrolyte for causing the reactions in formulas (1) and (2).

With the above configuration, when methanol is used as the fuel, the methanol supplied to the fuel electrode is decomposed by the catalyst when it reached the catalyst through fine pores in the electrode. As a result, electrons and hydrogen ions are produced by the electrochemical reaction shown in formula (1). The hydrogen ion reaches the oxidation electrode through the electrolyte and the solid electrolyte membrane between the two electrodes. Accordingly, water is produced as shown in formula (2) through the reaction of the hydrogen ions with oxygen, supplied to the oxidation electrode, and electrons flown into the oxidation electrode via an external circuit.

On the other hand, electrons emitted from the methanol by the electrochemical reaction shown in the formula (1) are extracted to an external circuit through a catalyst carrier and an electrode substrate, and flow into the oxidation electrode via the external circuit. Accordingly, since the electrons flow from the fuel electrode to the oxidation electrode via the external circuit, the electric power can be taken out.

In a conventional direct methanol fuel cell, carbon dioxide produced by formula (1) or carbon monoxide, which is an intermediate of the reaction in formula (1), prevents from supplying a fuel by accumulating them in fine pores in the fuel electrode. As a result, an efficiency of the power generation is reduced. The electric power is also reduced by decrease in an effective surface area of the catalyst. For avoiding these issues, foamy gases such as carbon dioxide and/or carbon monoxide or the like adsorbed on the surface of the electrode must be removed.

### DISCLOSURE OF THE INVENTION

The present invention has been made considering the above issues in the background art. Therefore, it is an object of the present invention to provide a liquid fuel that is capable of preventing from lowering power generation of a fuel cell when it is used for the fuel cell. This is achieved by suppressing adsorption of gases produced as byproducts on the electrode surface as well as quickly removing foamy gases adsorbed on the electrode, and thereby preventing from decreasing in an effective surface area of a fuel electrode.

It is another object of the present invention to provide a fuel cell of which fuel electrode is supplied with a liquid fuel that is capable of preventing from lowering power generation of the fuel cell when it is used for the fuel cell. This is also achieved by suppressing adsorption of gases produced as byproducts on the electrode surface as well as by quickly removing foamy gases adsorbed on the electrode, and thereby preventing from decreasing in an effective surface area of the fuel electrode.

It is an additional object of the present invention to provide a method for using a fuel cell of which fuel electrode is supplied with a liquid fuel that is capable of preventing from lowering power generation of the fuel cell when it is used for the fuel cell. The above is achieved by suppressing adsorption of gases produced as byproducts on the electrode surface as well as quickly removing foamy gases adsorbed on the electrode, and thereby preventing from decreasing in an effective surface area of the fuel electrode.

A first aspect of the present invention relates to a liquid fuel for a fuel cell containing an organic compound and at least one anti foaming agent.

The organic compound contains a carbon atom and a hydrogen atom.

An anti foaming effect of the anti foaming agent mixed into the liquid fuel of the present invention has effects of preventing from adsorbing of foamy gases produced by a reaction on a fuel electrode of the fuel cell and quick breaking and removing of the foams. With the above effects, the fuel cell is capable of preventing from decreasing in the power generation by mixing the anti foaming agent into the liquid fuel for the fuel cell.

In the liquid fuel according to the present invention, the anti foaming agent may include at least one selected from the group consisting of a fatty acid-based anti foaming agent, a fatty acid ester-based anti foaming agent, an alcohol-based anti foaming agent, an ether-based anti foaming agent, a phosphoric ester-based anti foaming agent, an amine-based anti foaming agent, an amide-based anti foaming agent, a metallic soap-based anti foaming agent, a sulfuric ester-based anti foaming agent, a silicone-based anti foaming agent, a mineral oil-based anti foaming agent, and also, polypropylene glycol, low-molecular-weight polyethyleneglycol oleic ester, a low-mole-addition product of nonyl phenol ethylene oxide, and a low-mole-addition product of pluronic-type ethylene oxide.

The fuel cell can be prevented from decreasing in the power generation by suppressing adsorption of the foams on the catalyst electrode of the fuel cell as well as quickly breaking and removing of the foams.

An optimum concentration of the anti foaming agent mixed into the liquid containing the organic compound is, although it depends on the kind of anti foaming agent, typically no less than 0.00001 w/w % and no more than 2 w/w %. With concentration of no less than 0.00001 w/w %, a quick removing effect of the foams appears. When the concentration is no more than 2 w/w %, a stability of the anti forming agent dispersed in the liquid fuel is maintained well.

The liquid fuel for a fuel cell of the present invention may contain one kind of anti foaming agent or a plurality of kinds of anti foaming agent.

In addition, the liquid fuel of the present invention may contain a mixing promoter and/or a stabilizer for the anti foaming agent as well as the anti foaming agent thereof. With the above, a power generation of the fuel cell is further increased.

A second aspect of the present invention relates to a method for using a fuel cell. The method is used for the fuel cell comprising a solid electrolyte membrane, a fuel electrode, and an oxidation electrode. Both electrodes are adjacent to the solid electrolyte membrane. The fuel cell is supplied with the liquid fuel containing the anti foaming agent to the fuel electrode.

The method for using the fuel cell according to the present invention is used for supplying the liquid fuel, which contains the anti foaming agent, to the fuel electrode. Therefore, the anti foaming agent prevents the foamy gases produced by the reaction on the fuel electrode from adsorbing, and also quickly breaks and removes the foams from the surface of the electrode.

Accordingly, an effective surface area of the fuel electrode is increased, thereby resulting in increase of power generation of the fuel cell.

A third aspect of the present invention relates to a fuel cell comprising a solid electrolyte membrane, a fuel electrode, and an oxidation electrode. The both electrodes are adjacent to the solid electrolyte membrane. The fuel cell is supplied with a liquid fuel containing the anti foaming agent to the fuel electrode.

In the fuel cell according to the present invention, the liquid fuel containing the anti foaming agent is supplied to the fuel electrode. Therefore, gases produced by a reaction on the fuel electrode are prevented from adsorbing on the electrode as foamy gases. Also, the generated foams are quickly broken and removed from the surface of the electrode.

Accordingly, an effective surface area of the fuel electrode increases, as a result, the power generation is also increased.

### BRIEF DESCRIPTION OF THE DRAWINGS

FIG. 1 is a schematic cross sectional view showing one of the typical example of internal configuration of a fuel cell in the present invention;

FIG. 2 is a schematic cross sectional view showing a fuel electrode, an oxidation electrode, and a solid electrolyte membrane in one of the typical example of a fuel cell in the present invention.

### BEST MODES FOR CARRYING OUT THE INVENTION

The present invention relates to supplying a liquid fuel that is capable of increasing power generation of a fuel cell when it is used for a fuel cell. This is achieved by suppressing adsorption of gases produced as byproducts on a fuel electrode as well as quickly removing the adsorbed foamy gases, and thereby increasing in an effective area of a catalyst.

Preferred embodiments of the present invention described below are typical ones among the embodiments that achieve a plurality of embodiments according to the present invention, on which a sufficient explanation has been given in the above description. A main subject of the present invention has already been explained sufficiently in the above description. In addition to the above, further explanations on one or more appropriate embodiments by referring to figures may help better understanding for the preferred embodiments.

The liquid fuel of the present invention contains an organic compound and at least one kind of anti foaming agent. Reaction products or byproducts of the organic compound that is a major composition of the liquid fuel are produced as gases when the liquid fuel of the present invention is supplied to a catalyst electrode of the fuel cell. However, even if foams are generated, the anti foaming agent, at least one kind of agent, mixed into the liquid fuel prevents from adsorbing of the foams on the electrode, and also if the foams are adsorbed on the electrode surface, the foams are quickly broken and removed from the electrode surface. Accordingly, lowering of power generation efficiency due to decrease in an effective area of the catalyst electrode and lowering of power generation of the fuel cell can be suppressed.

A typical organic compound contained in the liquid fuel of the present invention contains carbon atoms and hydrogen atoms. The organic compound may include, for example, alcohols such as methanol, ethanol, propanol, ethers such as dimethy ether, cycloparaffins such as cyclohexane, cycloparaffins having a hydrophilic group such as a hydroxyl group, carboxyl group, amino group, amide group, and a one-substitution product or two-substitution product of cycloparaffin. However, the organic compounds is not limited to the above. Cycloparaffins herein are cycloparaffin and its substitution products except aromatic compounds.

A typical anti foaming agent contained in the liquid fuel of the present invention may include, for example, a fatty acid-based anti forming agent, a fatty acid ester-based anti foaming agent, an alcohol-based anti foaming agent, an ether-based anti foaming agent, a phosphoric ester-based anti foaming agent, an amine-based anti foaming agent, an amide-based anti foaming agent, a metallic soap-based anti foaming agent, a sulfuric ester-based anti foaming agent, a silicone-based anti foaming agent, other organic polar compound-based anti foaming agents, and a mineral oil-based anti foaming agent. However, the anti foaming agent is not limited to the above.

An optimum concentration of the anti foaming agent mixed into the liquid containing the organic compound is, although it depends on the kind of anti foaming agent, typically no less than 0.00001 w/w % and no more than 2 w/w %. With concentration of no less than 0.00001 w/w %, a quick removing effect of the foams appears. When the concentration is no more than 2 w/w %, a stability of the anti forming agent dispersed in the liquid fuel is maintained well.

A typical fatty acid-based anti foaming agent may include stearic acid, oleic acid, and palmitic acid, but is not limited to these. It is favorable that the fatty acid-based anti foaming agent is mixed into the liquid containing the organic compound with concentration of, for example, no less than 0.001 w/w % and no more than 2 w/w %. When the concentration of the fatty acid-based anti foaming agent is no less than 0.001 w/w %, the foams on the surface of fuel electrode are quickly removed. On the other hand, when the concentration is no more than 2 w/w %, the stability of the dispersed anti forming agent is maintained well.

A typical fatty acid ester-based anti foaming agent may include isoamyl stearate, distearyl succinete, ethylene glycol distearate, sorbitan monolaurate ester, polyoxyethlene sorbitan monolaurate ester, sorbitan oleate triester, butyl stearate, glyceryl monoricinoleate ester, diethylene glycol monooleic ester, diglycol esterdinaphthenate ester, and monoglyceride. However, it is not limited to the above. When isoamyl stearate, or distearyl succinete, or ethylene glycol distearate is used as a fatty acid ester-based anti foaming agent, it is possible to mix the anti forming agent into the liquid containing the organic compound with concentration of no less than 0.05 w/w % and no more than 2 w/w %. When a fatty acid ester-based anti foaming agent other than the above is used, it is favorable to mix the anti forming agent into the liquid containing the organic compound with concentration of no less than 0.002 w/w % and no more than 0.2 w/w %. For each case in the above, when the concentration of the fatty acid ester-based anti foaming agent is no less than 0.05 w/w % and no less than 0.002 w/w %, respectively, if the liquid is supplied to the catalyst electrode of the fuel cell, the foams on the electrode surface are quickly removed. When the concentrations of the fatty acid ester-based anti foaming agents are no more than 2 w/w % and no more than 0.2 w/w %, respectively for each case in the above, the stability of the dispersed anti forming agent is maintained well.

An alcohol-based anti foaming agent in the present invention includes a higher alcohol-based anti foaming agent and a long chain alcohol-based anti foaming agent. A typical alcohol-based anti foaming agent may include polyoxyalkyleneglycol and its derivatives, polyoxyalkylene monohydricalcohol di-t-amyl-phenoxyethanol, 3-heptanol, 2-ethyl hexanol, and di-isobutyl-carbinol. However, it is not limited to the above.

When polyoxyalkyleneglycol and its derivatives are used for the alcohol-based anti foaming agent, the optimum concentration of the anti foaming agent mixed into the liquid containing the organic compound is no less than 0.001 w/w % and no more than 0.01 w/w %. When an alcohol-based anti foaming agent other than these described in the above is used, it is favorable that the anti foaming agent is mixed into the liquid containing the organic compound with concentration of no less than 0.025 w/w % and no more than 0.3 w/w %. When the liquid fuel is supplied to the catalyst electrode of the fuel cell, the foams on the fuel electrode are quickly removed in each case described in the above with concentration of no less than 0.001 w/w % and more then 0.025 w/w %, respectively. Also, in each case described in the above, the stability of the dispersed anti foaming agent is maintained well with concentration of no more than 0.01 w/w % and no more than 0.3 w/w %, respectively.

A typical ether-based anti foaming agent may include di-t-amyl-phenoxyethanol, 3-heptyl cellosolve nonyl cellosolve, 3-heptyl-carbitol, but is not limited to these. When these an anti foaming agent are used, it is favorable that the anti foaming agent is mixed into the liquid containing the organic compound with concentration of no less than 0.025 w/w % and no more than 0.25 w/w %. With concentration of no less than 0.025 w/w %, a quick removing effect of the foams appears when the liquid fuel is supplied to the catalyst electrode of the fuel cell. With the concentration of no more than 0.25 w/w %, the stability of the anti forming agent dispersed in the liquid fuel is maintained well.

A typical phosphoric ester-based anti foaming agent may include tributyl phosphate, sodium octyl phosphate, and tris (butoxyethyl) phosphate, but is not limited to these. When these phosphoric ester-based anti foaming agent are used, it is favorable that the anti foaming agent is mixed into the liquid containing the organic compound with concentration of no less than 0.001 w/w % and no more than 2 w/w %. Also, with concentration of no less than 0.001 w/w %, foams on the fuel electrode are quickly removed when the liquid fuel is supplied to the catalyst electrode of the fuel cell. With concentration of no more than 2 w/w %, the stability of the dispersed anti foaming agent is maintained well.

A typical amine-based anti foaming agent may include diamyl amine. However, it is not limited to this. When di-amyl-amine is used, it is favorable that the anti foaming agent is mixed into liquid containing the organic compound with concentration of no less than 0.02 w/w % and no more than 2 w/w %. Also, with concentration of no less than 0.02 w/w %, the foams on the fuel electrode are quickly removed when the liquid fuel is supplied to the catalyst electrode of the fuel cell. With concentration of no more than 2 w/w %, the stability of the dispersed anti foaming agent is maintained well.

A typical amide-based anti foaming agent may include polyalkylene amide, acylate polyamine, and di-octadecanoyl piperazine. However, it is not limited to these. When these amide-based anti foaming agent are used, it is favorable that the anti foaming agent is mixed into the liquid that contains the organic compound with concentration of no less than 0.002 w/w % and no more than 0.005 w/w %. Also, with concentration of no less than 0.002 w/w %, the foams on the fuel electrode are quickly removed when the liquid fuel is supplied to the catalyst electrode of the fuel cell. With concentration of no more than 0.005 w/w %, the stability of the dispersed anti foaming agent is maintained well.

A typical metallic soap-based anti foaming agent may include stearate aluminium, calcium stearate, potassium oleate, and calcium salt of wool oleic acid. However, it is not limited to these agents. When these metallic soap-based anti foaming agent are used, it is possible to mix the anti foaming agent into liquid that contains the organic compound with concentration of no less than 0.01 w/w % and no more than 0.5 w/w %. Also, with concentration of no less than 0.01 w/w %, the foams on the fuel electrode are quickly removed when the liquid fuel is supplied to the catalyst electrode of the fuel cell. With concentration of no more than 0.5 w/w %, the stability of the dispersed anti foaming agent is maintained well.

A typical sulfuric ester-based anti foaming agent may include laurate ester sodium. However, it is not limited to this. When laurate ester sodium is used, it is favorable that the anti foaming agent is mixed into liquid that contains the organic compound with concentration of no less than 0.002 w/w % and no more than 0.1 w/w %. Also, with concentration of no less than 0.002 w/w %, the foams on the fuel electrode are quickly removed when the liquid fuel is supplied to the catalyst electrode of the fuel cell. With concentration of no more than 0.1 w/w %, the stability of the dispersed anti foaming agent is maintained well.

A typical silicone-based anti foaming agent may include dimethyl polysiloxane, silicone paste, silicone emulsion, siliconized powder, organic modifier polysiloxane, and fluorine silicone. However, it is not limited to these agents. When these silicone-based anti foaming agent are used, it is favorable that the anti foaming agent is mixed into the liquid that contains the organic compound with concentration of no less than 0.00002 w/w % and no more than 0.01 w/w %. With concentration of no less than 0.00002 w/w %, the foams on the fuel electrode are quickly removed when the liquid fuel is supplied to the catalyst electrode of the fuel cell. Also, with concentration of no more than 0.01 w/w %, the stability of the dispersed anti foaming agent is maintained well.

A typical other organic polar compound-based anti foaming agent may include polypropylene glycol, low-molecular-weight polyethylene glycol oleic ester, low-mole-addition product of nonyl phenol ethylene oxide (EO), and low-mole-addition product of Pluronic-type ethylene oxide (EO). However, it is not limited to the above. When these organic polar compound-based anti foaming agent are used, it is favorable that the anti foaming agent is mixed into the liquid containing the organic compound with concentration of no less than 0.00001 w/w % and no more than 2 w/w %. With concentration of no less than 0.00001 w/w %, the foams on the fuel electrode are quickly removed when the liquid fuel is supplied to the catalyst electrode of the fuel cell. Also, with concentration of no more than 2 w/w %, the stability of the dispersed anti foaming agent is maintained well.

A typical mineral oil-based anti foaming agent may include a compound agent of a mineral oil-based surface active agent, and a compound agent of a mineral oil and a fatty acid metal salt-based surface active agent. However, it is not limited to these. When these mineral oil-based anti foaming agent is used, it is favorable that the anti foaming agent is mixed into the liquid containing the organic compound with concentration of no less than 0.01 w/w % and no more than 2 w/w %. With concentration of no less than 0.01 w/w %, the foams on the fuel electrode are quickly removed when the liquid fuel is supplied to the catalyst electrode of the fuel cell. Also, with concentration of no more than 2 w/w %, the stability of the dispersed anti foaming agent is maintained well.

The liquid fuel for a fuel cell of the present invention, which contains, for example, chemicals described in the above, is able to quickly remove the foams of carbon dioxide and/or carbon monoxide generated on the surface of the catalyst when the liquid fuel is used in the fuel cell. Therefore, an effective surface area of the catalyst electrode is secured, and thereby, an output power of the fuel cell is increased.

The anti foaming agent can be used independently. Mixing of no less than one kind of anti foaming agent is also possible. It is favorable that the mixed agent is dissolved or dispersed into the liquid fuel. A typical combination of plural kinds of anti foaming agent may include a combination of stearic acid 0.1 w/w %, tributyl phosphate 0.01 w/w %, and dimethyl polysiloxane 0.005 w/w %, and a combination of sorbitan oleate triester 0.05 w/w %, 3-heptyl carbitol 0.1 w/w %, diamyl amine 0.1 w/w %, stearate aluminum 0.05 w/w %, and laurate ester sodium. However, the combination is not limited to the above.

If necessary, as a mixing promoter or a dispersion stabilizer for anti foaming agent, for example, one of or a plurality of surfactants and an inorganic powder such as calcium carbonate can be mixed into the liquid fuel. For example, polyethylene glycol laurate diester is capable of using as the surfactant. It is favorable that the surfactant is mixed into the liquid containing the organic compound with concentration of no less than 0.00001 w/w % and no more than 2 w/w %.

In addition, increase in agitation speed and adding a vibration to the fuel are effective as well for increasing anti foaming effect of the anti foaming agent contained in the liquid fuel.

The fuel cell of the present invention comprises a fuel electrode, an oxidation electrode, and electrolyte. Both of the fuel electrode and the oxidation electrode are called as catalyst electrode. An organic compound containing carbon atoms and hydrogen atoms, and a liquid fuel for a fuel cell including an anti foaming agent are supplied to the fuel electrode.

The method for using the fuel cell of the present invention relates to supplying the organic compound containing carbon atoms and hydrogen atoms and the liquid fuel for a fuel cell including the anti foaming agent to the fuel electrode.

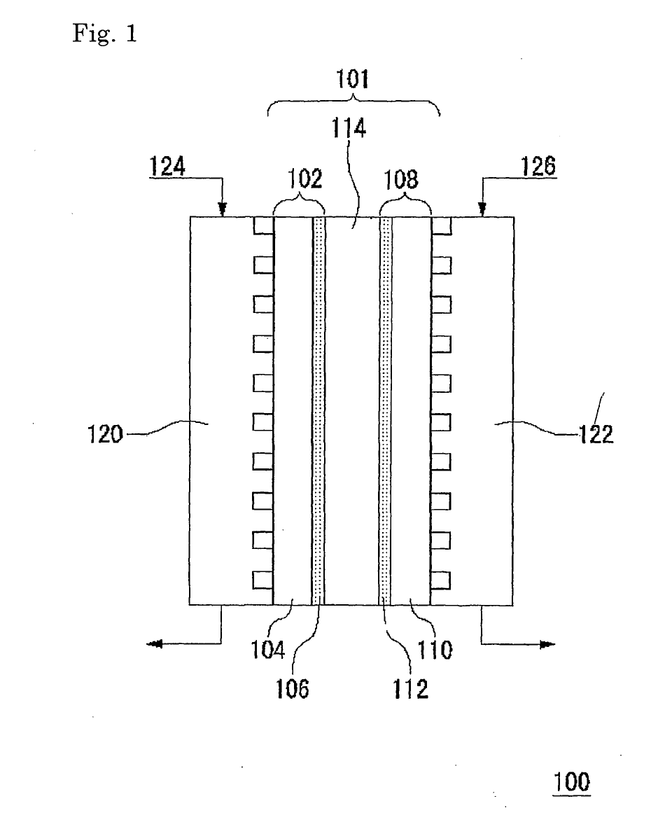

FIG. 1 is a schematic cross sectional view showing a structure of a fuel cell of the present invention. A joint member 101 that joins two catalyst electrodes and a solid electrolyte membrane is composed of a fuel electrode 102, an oxidation electrode 108, and a solid electrolyte membrane 114. The fuel electrode 102 is further composed of a substrate 104 and catalyst layer 106. Also, the oxidation electrode 108 is further composed of a substrate 110 and catalyst layer 112. The fuel cell 100 is composed of the joint member 101 joining a plurality of catalyst electrodes and the solid electrolyte membrane, and separators 120 and 122 disposed at fuel electrode side and at oxidation electrode side, respectively. The separators 120 and 122 sandwich the joint member 101.

In the above fuel cell 100, a fuel 124 is supplied to the fuel electrode 102 of the joint member 101, which is composed of the catalyst electrodes and the solid electrolyte membrane, through the separator 120 disposed at the fuel electrode side. In addition, an oxidizer such as air or oxygen is supplied to the oxidation electrode 108 of the joint member 101, which is composed of the catalyst electrodes and the solid electrolyte membrane, through the separator 122 disposed at the oxidation electrode side. The solid electrolyte membrane 114 of the fuel cell of the present invention has a role of transfer medium for hydrogen ions and water molecules between the fuel electrode 102 and the oxidation electrode 108 as well as a role of a separator between the two electrodes 102 and 108. Therefore, it is preferable that the solid electrolyte membrane 114 has a high conductance for the hydrogen ions. In addition, it is preferable that the solid electrolyte membrane 114 is chemically stable and has a high mechanical strength. A typical preferred material which composes the solid electrolyte membrane 114 may include strong acids group such as a sulfone group, a phosphoric group, a phosphone group, a phosphine group, and an organic polymer having a polar group such as weak acids group, for example, a carboxyl group, but is not limited to these groups. A typical organic polymer for the above may include polymers containing aromatic compounds such as sulfonated poly (4-phenoxybenzoyl-1,4-phenylene), alkylsulfonated polybenzimidazole, copolymers such as polymers containing fluorine, for example, a polystyrene sulfonic copolymer, a polyvinyl sulfonic copolymer, a bridged alkylsulfonate derivative, a fluorocarbon polymer frame, sulfonic acid, copolymers obtained by copolymerizing acrylamides such as acrylamide-2-methylpropane sulfonic acid and acrylates such as a n-butyl metacrylate, a perfluorocarbon containing sulfo group (Nafion: registered trademark, product of Dupon Co., Aciplex: product of Asahi Kasei Co.), and a perfluorocarbon containing carboxyl group (Flemion S membrane: registered trademark, product of Asahi Glass Co.). However, it is not limited to these polymers. Selecting the polymers containing an aromatic polymer such as sulfonated poly (4-phenoxybenzoyl-1, 4-phenylene), alkylsulfonated polybenzimidazole, the organic liquid fuel is prevented from permeating, thereby resulting in suppression of decrease in power generation efficiency caused by a crossover.

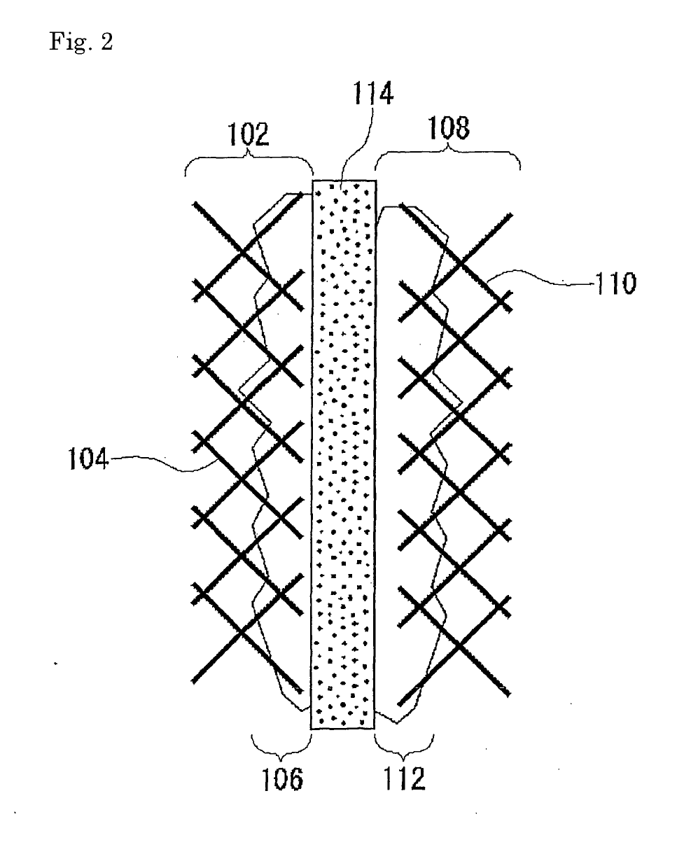

FIG. 2 is a schematic cross sectional view showing structures of fuel electrode 102, oxidation electrode 108 and solid electrolyte membrane 114 of the fuel cell in FIG. 1. As shown in the figure, each of fuel electrode 102 and oxidation electrode 108 of this embodiment may comprise, for example, carbon particles supporting a catalyst and fine particles of solid polymer electrolyte. The fuel electrode 102 is composed of a substrate 104 and a catalyst layer 106 formed on the substrate 104. The oxidation electrode 108 is composed of a substrate 110 and a catalyst layer 112 formed on the substrate 110. The substrates 104 and 110 may be subjected to a water repellant treatment.

For example, porous substrates such as carbon paper, carbon compact, sintered carbon, sintered metal, and foamed metal may be used for the substrates 104 and 110. Also, for example, polytetrafluoro ethylene can be used as a water repellant agent for the water repellant treatment. Platinum, Platinum-Rhodium, Palladium, Iridium, Osmium, Ruthenium, Rhenium, Gold, Nickel, Cobalt, Lithium, Lanthanide, Strontium, and Yttrium are exemplified as a catalyst of the fuel electrode 102. The above materials may be used independently and also in combination of no less than one material. As for the catalyst of the oxidation electrode 108, the catalyst may be either the same as, or different from that of the fuel electrode 102. Then, the catalyst of the fuel electrode 102 and oxidation electrode 108 may be same in some case and may be different in other case.

For example, an acetylene black (Denka Black: registered trademark, product of Denki Kagaku Kogyo K.K., XC72: product of Vulcan Materials Co.), a ketjenblack, an amorphous carbon, a carbon nanotube, a carbon nanohorn are exemplified as carbon particles carrying a catalyst. A diameter of the carbon particle is, for example, no less than 0.01 μm and no more than 0.1 μm, and preferably, no less than 0.02 μm and no more than 0.06 μm.

The solid polymer electrolyte composing the catalyst fuel electrode 102 and the oxidation electrode 108 has a role for transporting the organic liquid fuel to the surface of the catalyst as well as electrically connecting the catalyst carrier carbon particles and the solid electrolyte membrane 114 at the surface of the catalyst electrodes. Therefore, conductivity for hydrogen ions and water movability are required to the solid polymer electrolyte. In addition, permeability for the organic liquid fuel such as methanol is required to the fuel electrode 102. Permeability for oxygen is also required to the oxidation electrode 108. For complying these requirements, a material that has a superior conductivity for hydrogen ions and a superior permeability for organic liquid fuels such as methanol is preferable for the solid polymer electrolyte.

Practically, organic polymers such as strong acids group, for example, a sulfo group and a phosphoric group, and weak acids group having a polar group, for example, a carboxyl group are favorably used for the solid polymer electrolyte. An example of typical solid polymer electrolyte may include perfluorocarbons containing a sulfo group such as Nafion (product of Dupon Co.), Asiplex (product of Asahi Kasei Co.), perfluorocarbons containing a carboxyl group such as Flemion S membrane (product of Asahi Glass Co.), copolymers such as polymers containing fluorine, for example, a polystyrene sulfonic copolymer, a polyvinyl sulfonic copolymer, a bridgedalkyl sulfonic derivative, a fluorocarbon polymer frame, sulfonic acid, and copolymers obtained by copolymerizing acrylamides such as acrylamide-2-methylpropane sulfonic acid and acrylates such as a n-butyl metacrylate. However, it is not limited to the above electrolytes.

Other typical example of polymer to which a polar group bonds may include a polybenzimidazole derivative, a polybenzoxazole derivative, a bridged polyethylene imine, a polythyramine derivative, an amine-substituted polystyrene such as a polydiethylaminoethyl polystyrene, a resin having nitrogen or a hydroxyl group such as a nitrogen-substituted polyacrylate, for example, a diethylaminoethyl polymethacrylate, a poly-siloxane, a polyacryl resin containing a hydroxyl group exemplified by a hydroxyethylpolymethyl acrylate, and a polystyrene resin containing a hydroxyl group exemplified by a parahydroxy polystyrene. However, it is not limited to the above.

A bridged substitution group such as a vinyl group, an epoxy group, an acryl group, a methacryl group, a cinnamoyl group, a methylore group, an azide group, and a naphthoquinone diazide may suitably be introduced into the above polymer.

The above solid polymer electrolyte in the fuel electrode 102 and the oxidation electrode 108 may be the same in some case and may be different in other case.

Next, a production method for the fuel cell according to the present invention will be explained in detail.

There is not a specific method for producing the fuel electrode and the oxidation electrode of the present invention. For example, both electrodes may be produced with the following procedure.

A catalyst on the fuel electrode and the oxidation electrode is supported on carbon particles by an immersion method in general. Catalyst carrier carbon particles and solid polymer electrolyte particles are dispersed in a solvent to form a paste. The paste is coated on a substrate and dried to make the fuel electrode and the oxidation electrode. A diameter of the carbon particle is, for example, no less than 0.01 μm and no more than 0.1 μm. A diameter of the catalyst is, for example, no less than 1 nm and no more than 10 nm. Also, a diameter of the solid polymer electrolyte particle is, for example, no less than 0.05 μm and no more than 1 μm. The carbon particles and the solid polymer electrolyte particles are used in the ratio of, for example, 2:1˜40:1 in weight. Also, the ratio of water and the solute in the paste is, for example, about 1:2˜10:1.

There is no specific method for applying the paste to the substrate. For example, a brush painting, a spray application, and a screen printing may be used. The paste is applied to the substrate, for example, about no less than 1 μm and no more than 2 mm in thickness. After applying the paste, the substrate is heat treated at a temperature and a time corresponding to the characteristics of fluorocarbon polymer used in the process. Thus, the fuel electrode and the oxidation electrode are fabricated from the substrate prepared in the above. The temperature and the time for the heat treatment are suitably selected according to the materials. For example, regarding the temperature, no less than 100° C. and no more than 250° C., and also regarding the time, no less than 30 sec and no more than 30 min may be selected.

The solid electrolyte membrane according to the present invention may be suitably fabricated considering the materials to be used. For example, when the solid electrolyte membrane is made of organic polymer material, the solid electrolyte membrane is fabricated by casting a liquid, in which the organic polymer material is dissolved or dispersed in a solvent, on an exfoliating sheet such as polytetra-fluoro-ethylene, and drying it.

A joint member of the electrode and the electrolyte is fabricated by sandwiching the solid electrolyte membrane with both of the fuel electrode and the oxidation electrode, and hot pressing it. In this process, catalyst surfaces on both electrodes and the solid electrolyte membrane are contacted to each other. Conditions for the hot pressing are selected considering the characteristics of the materials to be used. When the solid electrolyte membrane and an electrolyte film on the electrode surfaces are made of an organic polymer having a softening temperature or a glass transition temperature, the hot pressing temperature may be higher than the softening temperature and the glass transition temperature. Specifically, for example, the temperature is higher than 100° C. and lower than 250° C., the pressure is higher than 1 kg/cm2 and lower than 100 kg/cm2, and the time is longer than 10 sec and shorter than 300 sec.

The fuel cell fabricated through the above procedure is capable of increasing the power generation of the fuel cell since the effective surface area of the catalyst electrode is maintained by quickly removing the foams such as carbon dioxide, carbon monoxide and the like generated on the catalyst layer surface of the fuel electrode by mixing an anti foaming agent in the liquid fuel that is supplied to the fuel electrode.

### First Embodiment

A mixed fuel mixing an anti foaming agent has been compounded as an organic liquid fuel for a fuel cell. That is, the anti foaming agent described in Table 1 is mixed into a methanol solution and an ethanol solution, both of which have concentration of 30 v/v %, with concentration described in Table 1 for each solution. A catalyst electrode of the fuel cell has been fabricated as follows for evaluating the mixed fuel.

A catalyst paste is prepared such that 3 ml of 5% Nafion solution manufactured by Aldrich Co. is added to ketjenblack 100 mg which carries Ruthenium-Platinum alloy and agitated 3 hours at 50° C. using super sonic mixer. The alloy has 50 atm % Ruthenium. The ratio of the alloy and the fine carbon particles (i.e., ketjenblack) is 1:1 in weight. The catalyst electrode is fabricated by coating the paste with 2 mg/cm2 on a carbon paper (TGP-H-120: product of TORAY Industries Inc.) having an area of 1 cm×1 cm, and drying it at 120° C.

The catalyst electrode for a fuel cell prepared in the above is put in a container in which the fuel is supplied continuously to the surface of the catalyst electrode and the surface can be inspected with an optical microscope.

Each of the mixed fuel, that is, the methanol based fuel and the ethanol based fuel, is supplied to the catalyst electrode of the fuel cell with flow rate 5 ml/min, and the status of the catalyst electrode surface has been inspected with the optical microscope. The inspection was repeated 10 times for each mixed fuel.

From the inspection, it was found that diameter of the generated foams was no more than 10 μm, and that the foam has left the electrode surface just after the generation thereof and was flown together with the fuel. Adsorption of the foams on the catalyst electrode surface has not been observed at one hour later after starting the experiment.

The gases generated in the above experiment was collected and chemically analyzed with a gas chromatography. By the analysis, carbon dioxide and carbon monoxide have been detected.

TABLE 1

| | | Concentration |
|---|---|---|
| Type | Anti-foaming agent | (w/w %) |
| Fatty acid-based | Stearic acid | 0.1 |
| | Oleic acid | 0.1 |
| | palmitic acid | 0.1 |
| Fatty acid | Isoamyl stearate | 0.5 |
| ester-based | distearyl succinete | 0.5 |
| | ethylene glycol distearate | 0.5 |
| | Sorbitan monolaurate ester | 0.05 |
| | Sorbitan oleate triester | 0.05 |
| | butyl stearate | 0.05 |
| | glyceryl monoricinoleate ester | 0.05 |
| | diethylene glycol monooleic ester | 0.05 |
| | diglycol esterdinaphthenate ester | 0.05 |
| | monoglyceride | 0.05 |
| Alcohol-based | Polyoxyalkyleneglycol | 0.01 |
| | 3-heptanol | 0.05 |
| | 2-ethyl hexanol | 0.05 |
| | di-isobutyl carbinol | 0.05 |
| Ether-based | di-t-amyl phenoxyethanol | 0.1 |
| | 3-heptyl cellosolve nonyl cellosolve | 0.1 |
| | 3-heptyl carbitol | 0.1 |
| Phosphate | tributyl phosphate | 0.01 |
| based | sodium octyl phosphate | 0.01 |
| | tris(butoxyethyl) phosphate | 0.01 |
| Amine-based | Diamyl amine | 0.1 |
| Amide-based | polyalkylene amide | 0.003 |
| | acylate polyamine | 0.003 |
| | di-octadecanoyl piperazine | 0.003 |
| Metal | stearate aluminum | 0.1 |
| soap-based | calcium stearate | 0.1 |
| | potassium oleate | 0.1 |
| Sulfate | laurate ester sodium | 0.05 |
| based | | |
| Silicone-based | dimethyl polysiloxane | 0.005 |
| | silicon paste | 0.005 |
| | silicon emulsion | 0.005 |
| | siliconized powder | 0.005 |
| | organic modifier polysiloxane | 0.005 |
| | fluorine silicone | 0.005 |
| Organic polar | Polypropylene glycol | 0.01 |
| compound-based | | |

### FIRST COMPARISON EXAMPLE

A similar inspection to the first embodiment has been conducted 10 times with 10 v/v % methanol solution and 10 v/v % ethanol solution. As a result, it was found that in the case of 10 v/v % methanol solution, a foam having a diameter of about 3 mm has been generated on the catalyst electrode surface at 5 minutes later from the contact of the fuel with the catalyst electrode surface. A part of the generated foams has left together with the fuel from the electrode surface. At one hour later after starting the inspection, 3˜5 foams have been found on the electrode surface. In the case of 10 v/v % ethanol solution, a similar phenomena to the case of methanol has been found that a foam having a diameter of about 3 mm has been generated on the catalyst electrode surface at 10 minutes later after supplying the fuel to the catalyst electrode surface, and 3˜5 foams have been found on the electrode surface at one hour later after starting the inspection.

The gases generated in the experiment was collected and chemically analyzed with a gas chromatography. As a result, carbon dioxide and carbon monoxide have also been detected by the analysis.

From the first embodiment and the first comparison example, it has been confirmed that the mixed fuel mixing an anti foaming agent has effects for preventing from adsorbing of carbon dioxide and carbon monoxide, which are generated on the catalyst electrode surface, to the electrode surface, and quickly removing the generated gases from the surface.

### Second Embodiment

A fuel cell has been fabricated using the catalyst electrode prepared in the first embodiment. That is, the catalyst electrode prepared in the first embodiment was heat pressed at 120° C. at both side of Nafion 117 (registered trademark, product of Dupon Co.). Then, a joint member of the catalyst electrode and the solid electrolyte membrane fabricated in the above process has been used for the fuel cell. A fuel mixing an anti foaming agent described in Table 1 into 30 v/v % methanol solution with the concentration in Table 1 was supplied to the fuel electrode of the fuel cell. On the other hand, oxygen was supplied to the oxidation electrode keeping the cell temperature at 60° C. Flow rates of the fuel and oxygen were 100 ml/min and 100 ml/min, respectively. A voltage-current characteristic of the fuel cell has been evaluated using a fuel cell evaluation apparatus for each fuel. The maximum output power for each fuel is shown in Table 2.

### SECOND COMPARISON EXAMPLE

With a similar method to the second embodiment, the voltage-current characteristic has been evaluated by supplying 30 v/v % methanol solution which does not contain an anti foaming agent to the fuel electrode of the fuel cell keeping the cell temperature at 60° C.

In this case, the maximum output power of the fuel cell was 43 mW/cm2. (Referred to in Table 2).

From the results of the second embodiment and the second comparison example, it has been confirmed that the power generation of the fuel cell has increased by mixing an anti foaming agent into the fuel.

TABLE 2

| | | Maximum output |
|---|---|---|
| Type | Anti-foaming agent | power (mW/cm²) |
| Fatty acid- | Stearic acid | 52 |
| based | Oleic acid | 52 |
| | palmitic acid | 52 |
| Fatty acid | Isoamyl stearate | 51 |
| ester-based | distearyl succinete | 52 |
| | ethylene glycol distearate | 51 |
| | Sorbitan monolaurate ester | 53 |
| | Sorbitan oleate triester | 50 |
| | butyl stearate | 51 |
| | glyceryl monoricinoleate ester | 52 |
| | diethylene glycol monooleic ester | 51 |
| | diglycol esterdinaphthenate ester | 50 |
| | monoglyceride | 52 |
| Alcohol-based | Polyoxyalkyleneglycol | 50 |
| | 3-heptanol | 49 |
| | 2-ethyl hexanol | 50 |
| | di-isobutyl carbinol | 51 |
| Ether-based | di-t-amyl phenoxyethanol | 52 |
| | 3-heptyl cellosolve nonyl cellosolve | 52 |
| | 3-heptyl carbitol | 51 |
| Phosphate | tributyl phosphate | 49 |
| based | sodium octyl phosphate | 50 |
| | tris(butoxyethyl) phosphate | 49 |
| Amine-based | Diamyl amine | 52 |
| Amide-based | polyalkylene amide | 51 |
| | acylate polyamine | 52 |
| | di-octadecanoyl piperazine | 53 |
| Metal | stearate aluminum | 50 |
| soap-based | calcium stearate | 52 |
| | potassium oleate | 51 |
| Sulfate | laurate ester sodium | 50 |
| based | | |
| Silicone-based | dimethyl polysiloxane | 51 |
| | silicon paste | 50 |
| | silicon emulsion | 52 |
| | siliconized powder | 50 |
| | organic modifier polysiloxane | 52 |
| | fluorine silicone | 51 |
| Organic polar | Polypropylene glycol | 50 |
| compound- | | |
| based | | |

| | |
|---|---|
| Only 30%(v/v)Ethanol(comparative example 2) | 43 |

### Third Embodiment

With a similar method to the second embodiment, a mixed fuel mixing an anti foaming agent described in Table 1 into 30 v/v % ethanol solution with the concentration in Table 1 was supplied to the fuel electrode of the fuel cell keeping the cell temperature at 60° C.

The maximum output power of the fuel cell for each fuel is shown in Table 3.

### THIRD COMPARISON EXAMPLE

With a similar method to the third embodiment, the voltage-current characteristic has been evaluated by supplying 30 v/v % ethanol solution which does not contain an anti foaming agent to the fuel electrode of the fuel cell keeping the cell temperature at 60° C.

In this case, the maximum output power was 30 mW/cm2. (Referred to in Table 3).

From the results of the third embodiment and the third comparison example, it has been confirmed that the power generation of the fuel cell has increased by mixing an anti foaming agent into the fuel, in which the main composition of the fuel is ethanol.

TABLE 3

| | | Maximum output |
|---|---|---|
| Type | Anti-foaming agent | power (mW/cm²) |
| Fatty acid- | Stearic acid | 42 |
| based | Oleic acid | 41 |
| | palmitic acid | 42 |
| Fatty acid | Isoamyl stearate | 41 |
| ester-based | distearyl succinete | 42 |
| | ethylene glycol distearate | 41 |
| | Sorbitan monolaurate ester | 43 |
| | Sorbitan oleate triester | 40 |
| | butyl stearate | 41 |
| | glyceryl monoricinoleate ester | 42 |
| | diethylene glycol monooleic ester | 41 |
| | diglycol esterdinaphthenate ester | 40 |
| | monoglyceride | 42 |
| Alcohol-based | Polyoxyalkyleneglycol | 40 |
| | 3-heptanol | 39 |
| | 2-ethyl hexanol | 40 |
| | di-isobutyl carbinol | 41 |
| Ether-based | di-t-amyl phenoxyethanol | 42 |
| | 3-heptyl cellosolve nonyl cellosolve | 42 |
| | 3-heptyl carbitol | 41 |
| Phosphate | tributyl phosphate | 39 |
| based | sodium octyl phosphate | 39 |
| | tris(butoxyethyl) phosphate | 39 |
| Amine-based | Diamyl amine | 41 |
| Amide-based | polyalkylene amide | 40 |
| | acylate polyamine | 41 |
| | di-octadecanoyl piperazine | 42 |
| Metal | stearate aluminum | 41 |
| soap-based | calcium stearate | 43 |
| | potassium oleate | 40 |
| Sulfate | laurate ester sodium | 39 |
| based | | |
| Silicone-based | dimethyl polysiloxane | 41 |
| | silicon paste | 40 |
| | silicon emulsion | 41 |
| | siliconized powder | 41 |
| | organic modifier polysiloxane | 40 |
| | fluorine silicone | 40 |
| Organic polar | Polypropylene glycol | 39 |
| compound- | | |
| based | | |

| | |
|---|---|
| Only 30%(v/v)Ethanol(comparative example 3) | 30 |

### Fourth Embodiment

In the second embodiment, the each fuel has been compounded by further mixing a polyethyleneglycol laurate diester into the fuel with concentration of 0.1 w/w % as a mixing promoter and a stabilizer for anti foaming agent. Using the above fuel, the voltage-current characteristic has been evaluated as in the case of the second embodiment.

The result is shown in Table 4. It has been obtained from the fuel cell that is supplied with the fuel that contains each anti foaming agent to the fuel electrode.

From Table 4, it has been confirmed that power generation of the fuel cell has increased by further mixing a polyethyleneglycol laurate diester as a mixing promoter and a stabilizer for anti foaming agent as well as anti foaming agent to the fuel.

TABLE 4

| | | Maximum output |
|---|---|---|
| Type | Anti-foaming agent | power (mW/cm²) |
| Fatty acid- | Stearic acid | 55 |
| based | Oleic acid | 56 |
| | palmitic acid | 54 |
| Fatty acid | Isoamyl stearate | 55 |
| ester-based | distearyl succinete | 54 |
| | ethylene glycol distearate | 56 |
| | Sorbitan monolaurate ester | 57 |
| | Sorbitan oleate triester | 56 |
| | butyl stearate | 57 |
| | glyceryl monoricinoleate ester | 56 |
| | diethylene glycol monooleic ester | 55 |
| | diglycol esterdinaphthenate ester | 56 |
| | monoglyceride | 57 |
| Alcohol-based | Polyoxyalkyleneglycol | 55 |
| | 3-heptanol | 56 |
| | 2-ethyl hexanol | 55 |
| | di-isobutyl carbinol | 57 |
| Ether-based | di-t-amyl phenoxyethanol | 55 |
| | 3-heptyl cellosolve nonyl cellosolve | 56 |
| | 3-heptyl carbitol | 57 |
| Phosphate | tributyl phosphate | 56 |
| based | sodium octyl phosphate | 55 |
| | tris(butoxyethyl) phosphate | 55 |
| Amine-based | Diamyl amine | 55 |
| Amide-based | polyalkylene amide | 56 |
| | acylate polyamine | 55 |
| | di-octadecanoyl piperazine | 56 |
| Metal | stearate aluminum | 56 |
| soap-based | calcium stearate | 55 |
| | potassium oleate | 55 |
| Sulfate | laurate ester sodium | 57 |
| based | | |
| Silicone-based | dimethyl polysiloxane | 55 |
| | silicon paste | 56 |
| | silicon emulsion | 55 |
| | siliconized powder | 55 |
| | organic modifier polysiloxane | 56 |
| | fluorine silicone | 56 |
| Organic polar | Polypropylene glycol | 56 |
| compound- | | |
| based | | |

| | |
|---|---|
| No antifoamer(comparative example 2) | 43 |

### Fifth Embodiment

For confirming an effect of mixing no less than one anti foaming agent into the fuel, a mixed fuel mixing anti foaming agent A: stearic acid 0.1 w/w %, tributyl phosphate 0.01 w/w %, dimethyl polysiloxane 0.005 w/w %, or anti foaming agent B: sorbitan oleate triester 0.05 w/w %, 3-heptyl carbitol 0.1 w/w %, diamylamine 0.1 w/w %, stearate aluminum 0.05 W/W %, laurate ester sodium 0.05 w/w % into 30 v/v % methanol solution has been compounded separately.

The voltage-current characteristic has been evaluated with a similar method to the second embodiment when the each mixed fuel is supplied to the fuel cell.

The maximum power generation for each anti foaming agent A and B are 52 mW/cm2 and 51 mW.cm2, respectively. From the above, it has been confirmed that when the fuel is supplied to the fuel electrode, the effect of anti foaming agent is maintained even if no less than one anti foaming agent are mixed into the fuel as well as in the case of one anti foaming agent.

From the above embodiments, it has been confirmed that the fuel of the present invention is capable of increasing the power generation of the fuel cell. This is achieved by increasing the effective surface area of the catalyst electrode through quick breaking and removing of the foams generated on the catalyst electrode surface of the fuel cell by mixing anti foaming agents into the fuel.

In these embodiments, methanol and ethanol solutions have been used for the fuel. However, when alcohols such as propanol, ethers such as dimethylether, cycloparaffins such as cyclohexane, cycloparaffins having a hydrophilic group such as a hydroxyl group, a carboxyl group, an amino group, an amide group, and a substitution product of cycloparaffin are used for the fuel, a similar effect to the above embodiments has been obtained.

### INDUSTRIAL APPLICABILITY

According to the present invention, since an anti foaming agent is mixed into the fuel, when the fuel is used for a fuel cell, adsorption of gases, which are produced as byproducts, on the fuel electrode is suppressed as well as quickly breaking and removing the foamy gases adsorbed on the electrode from the surface, thereby an effective catalyst area of the fuel electrode is increased. Accordingly, a liquid fuel that is capable of increasing the power generation of the fuel cell is realized.

In addition, according to the present invention, a fuel cell that is supplied with the liquid fuel to the fuel electrode, and a method for using the fuel cell are also realized.

The present invention may be embodied in other specific forms without departing from the spirit or essential characteristics of it. The present embodiments are therefore to be considered in all respects as illustrative and not restrictive, the scope of the present invention being indicated by the appended claims rather than by the foregoing description and all changes which come within the meaning and range of equivalency of the claims are therefore intended to be embraced therein. It is possible to implement many other modifications, or improved embodiment by skilled people.

1. A liquid fuel for a fuel cell comprising an organic compound and at least one kind of anti foaming agent removing gases produced by decomposition of the said organic compound:

2. A liquid fuel for a fuel cell as claimed in claim 1, wherein the anti foaming agent comprises at least one selected from a group consisting of a fatty acid-based anti forming agent, a fatty acid ester-based anti foaming agent, an alcohol-based anti foaming agent, an ether-based anti foaming agent, a phosphoric ester-based anti foaming agent, an amine-based anti foaming agent, an amide-based anti foaming agent, a metallic soap-based anti foaming agent, a sulfuric ester-based anti foaming agent, a silicone-based anti foaming agent, a mineral oil-based anti foaming agent, polypropylene glycol, polypropylene glycol, low-molecular-weight polyethylene glycol oleic ester, low-mole-addition product of nonyl phenol ethylene oxide, and low-mole-addition product of Pluronic-type ethylene oxide.

3. A liquid fuel for a fuel cell as claimed in claim 2, wherein an addition quantity of the anti foaming agent to the liquid fuel containing the organic compound is no less than 0.00001 w/w % and no more than 2 w/w %.

4. A liquid fuel for a fuel cell as claimed in claim 3, wherein the liquid fuel comprises one kind of anti foaming agent.

5. A liquid fuel for a fuel cell as claimed in claim 3, wherein the liquid fuel comprises a plurality of kinds of anti foaming agent.

6. A liquid fuel for a fuel cell as claimed in claim 3, wherein the liquid fuel comprises at least one out of a mixing promoter and a stabilizer for the anti foaming agent in addition to the anti foaming agent.

7. A method for using a fuel cell comprising:
a solid electrolyte membrane;
a fuel electrode adjacent to a first surface of the solid electrolyte membrane; and
an oxidation electrode adjacent to a second surface of the solid electrolyte membrane,
wherein the method is characterized in that the method further comprising:
supplying a liquid fuel for a fuel cell containing an organic compound and at least one kind of anti foaming agent to the fuel electrode.

8. A method for using a fuel cell as claimed in claim 7, wherein the anti foaming agent comprises at least one selected from a group consisting of a fatty acid-based anti forming agent, a fatty acid ester-based anti foaming agent, an alcohol-based anti foaming agent, an ether-based anti foaming agent, a phosphoric ester-based anti foaming agent, an amine-based anti foaming agent, an amide-based anti foaming agent, a metallic soap-based anti foaming agent, a sulfuric ester-based anti foaming agent, a silicone-based anti foaming agent, a mineral oil-based anti foaming agent, polypropylene glycol, polypropylene glycol, low-molecular-weight polyethylene glycol oleic ester, low-mole-addition product of nonyl phenol ethylene oxide, and low-mole-addition product of Pluronic-type ethylene oxide.

9. A method for using a fuel cell as claimed in claim 8, wherein an addition quantity of the anti foaming agent to the liquid fuel containing the organic compound is no less than 0.00001 w/w % and no more than 2 w/w %.

10. A method for using a fuel cell as claimed in claim 9, wherein the liquid fuel comprises one kind of anti foaming agent.

11. A method for using a fuel cell as claimed in claim 9, wherein the liquid fuel comprises a plurality of kinds of anti foaming agent.

12. A method for using a fuel cell as claimed in claim 9, wherein the liquid fuel comprises at least one out of a mixing promoter and a stabilizer for the anti foaming agent in addition to the anti foaming agent.

13. A fuel cell comprising:
a solid electrolyte membrane;
a fuel electrode adjacent to a first surface of the solid electrolyte membrane; and
an oxidation electrode adjacent to a second surface of the solid electrolyte membrane,
wherein the fuel cell is characterized in that the fuel cell is supplied with a liquid fuel that contains an organic compound and at least one kind of anti foaming agent removing gases produced by decomposition of the said organic compound to the fuel electrode.

14. A fuel cell as claimed in claim 13, wherein the anti foaming agent comprises at least one selected from a group consisting of a fatty acid-based anti forming agent, a fatty acid ester-based anti foaming agent, an alcohol-based anti foaming agent, an ether-based anti foaming agent, a phosphoric ester-based anti foaming agent, an amine-based anti foaming agent, an amide-based anti foaming agent, a metallic soap-based anti foaming agent, a sulfuric ester-based anti foaming agent, a silicone-based anti foaming agent, a mineral oil-based anti foaming agent, polypropylene glycol, polypropylene glycol, low-molecular-weight polyethylene glycol oleic ester, low-mole-addition product of nonyl phenol ethylene oxide, and low-mole-addition product of Pluronic-type ethylene oxide.

15. A fuel cell as claimed in claim 14, wherein an addition quantity of the anti foaming agent to the liquid fuel containing the organic compound is no less than 0.00001 w/w % and no more than 2 w/w %.

16. A fuel cell as claimed in claim 15, wherein the liquid fuel comprises one kind of anti foaming agent.

17. A fuel cell as claimed in claim 15, wherein the liquid fuel comprises a plurality of kinds of anti foaming agent.

18. A fuel cell as claimed in claim 15, wherein the liquid fuel comprises at least one out of a mixing promoter and a stabilizer for the anti foaming agent in addition to the anti foaming agent.
